(19) United States
(12) Patent Application Publication
(10) Pub. No.: US 2008/0244476 A1
(43) Pub. Date: Oct. 2, 2008

(54) System and method for simultaneous optimization of multiple scenarios in an integrated circuit design

(75) Inventors: Dimitris K. Fotakis, Saratoga, CA (US); Mattias Hembruch, Fremont, CA (US); Payam Kiani, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Athena Design Systems, Inc.

(21) Appl. No.: 11/732,384

(22) Filed: Apr. 2, 2007

(51) Int. Cl. G06F 17/50

(52) U.S. Cl. 716/4

(57) ABSTRACT

The present invention provides a system and method for concurrently performing analysis and optimization of an integrated circuit (IC) design in multiple scenarios. The system is based on a distributed computing model, where any optimization change introduced in one scenario is immediately tested in all other scenarios. This ensures that modifications made to the design do not affect other scenarios. The invention significantly reduces the execution time of the optimization and signoff flows in the design of ICs. In addition, the computing means required for simultaneously testing multiple scenarios are standard and affordable.

### BACKGROUND OF THE INVENTION

1. Field of the Invention

The present invention relates generally to an integrated circuit design system.

2. Prior Art

Complex electronic systems are typically designed using integrated circuits (ICs) comprising multiple functional blocks. A typical IC operates across a range of temperatures and voltages, provides economical yields across the manufacturing processes to be used, and functions in various functional modes.

Process corners or, for short, corners, are typically a combination of voltage, temperature and manufacturing process that has to be verified to ensure the proper operation of the IC. For example, in the case of timing paths, variations in the manufacturing processes used to fabricate the ICs, may result in faster or slower devices. In the same manner, if the supply voltage to the device is lower or higher than the nominal value, the device may run slower or faster, respectively. Similarly, a lower operating temperature may cause the device to run faster, while a higher operating temperature may cause the device to run slower.

To date, the number of corners that have been tested has been limited to two: a first corner for which variations in the manufacturing process combined with the lowest possible supply voltage and the highest operating temperature resulting in maximum (slowest) delays, and a second corner for which variations in the manufacturing process combined with the highest possible supply voltage and the lowest operating temperature resulted in the minimum delays. However, this does not equate to modern IC design developed using a 90 nanometer technology node or smaller. That is, the number of corners that should be tested for proper operation at 90 nm or smaller is double or more.

Furthermore, modern IC designs operate in a substantial number of functional modes. For example, a mobile telephone may operate in a search mode, an idle mode, a receive mode, and a transmit mode, in addition to a media player mode, a digital camera mode, a global positioning satellite (GPS) mode, and so on. Each operation mode has to be verified in isolation and with respect to switching from one mode to another. Moreover, each mode has to be verified with respect to the various corners. A combination of a corner and functional mode will be referred hereafter as a “scenario”.

Most of the traditional timing analysis and optimization tools used in IC design are capable of evaluating a single scenario comprising a single functional mode and a single corner at a time. As a result, the traditional design flow is based on analyzing and optimizing the design on a scenario-by-scenario basis. This introduces a major drawback as timing closure, in a design having multiple scenarios, may never be achieved. That is, optimizing the design to achieve timing closure in a first scenario may cause problems in a second scenario. Similarly, re-optimizing the design to achieve timing closure for the second scenario may introduce new problems in the first scenario or any other scenario.

Another approach for analyzing and optimizing multiple scenarios is based on merging the multiple scenarios into a single scenario. Specifically, this is performed by merging individual constraint files into a single constraint file. This file is then used to perform timing optimization and analysis for all scenarios simultaneously on a single expensive computing machine. Such a machine typically includes multiple CPUs and a large amount of memory. Other than using expensive computing means there are other drawbacks, such as the creation of the single constraint file which is a resource-intensive and time-consuming task. Additionally, in many cases, the constraints from two scenarios may be mutually exclusive. For example, a timing path may support a latency of only one clock cycle in one mode, but require a latency of three cycles in another mode.

Another drawback of conventional approaches is that the signoff timing verification engine is typically different from the timing analysis engine used to perform the design optimizations. That is, if the design fails its signoff verification for one scenario, the fix may disturb one or more of the other scenarios and the entire verification process has to be repeated.

Therefore, as current IC designs should satisfy a large number of scenarios, it would be advantageous to provide a solution for a concurrent multi-scenario optimization.

### BRIEF DESCRIPTION OF THE DRAWINGS

FIG. 1 is a diagram of an exemplary distributed multi-processing system for executing the process described in accordance with an embodiment of the present invention.

FIG. 2 is a layout of an IC design.

FIG. 3 is a non-limiting and exemplary flowchart describing the method for simultaneously multi-scenario optimization of IC designs in accordance with an embodiment of the present invention.

### DETAILED DESCRIPTION OF THE PREFERRED EMBODIMENTS

In order to address the drawbacks of prior art optimization solutions, the present invention provides a system and method for concurrently performing timing analysis and optimization of an integrated circuit (IC) design in multiple scenarios. The system is based on a distributed computing model, where any optimization change introduced in one scenario is immediately tested in all other scenarios. This ensures that modifications to the design do not affect other scenarios, or otherwise are taken into account. The invention significantly reduces the execution time of the optimization and signoff flows of IC designs. In addition, the computing means required for simultaneously testing multiple scenarios are standard and affordable. In accordance with the present invention, a scenario is a combination of a corner (i.e., any combination of a supply voltage, temperature, and manufacturing process) and a functional mode of the IC.

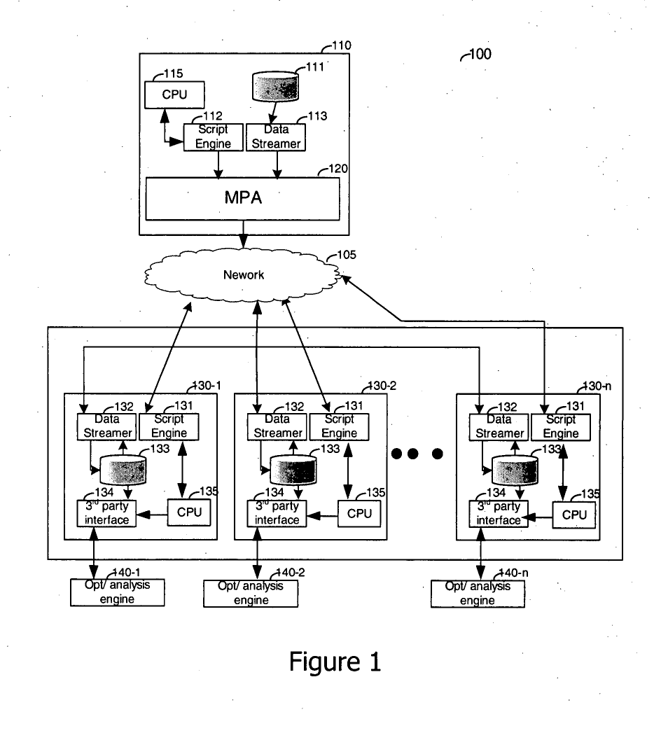

FIG. 1 shows a non-limiting diagram of an exemplary distributed multi-processing system 100 that can be utilized to concurrently perform analysis and optimization of an integrated circuit (IC) design in multiple scenarios in accordance with the present invention. The system 100 comprises a main computing node 110 and a plurality of distributed remote processing nodes 130. The main computing node 110 includes a main database 111 for holding design information, a script engine 112 for propagating scripts to be executed by remote processing nodes 130, a data streamer 113 for transferring binary data streams to remote processing nodes 130, and a multi-processing agent (MPA) 120. The MPA 120 is the infrastructure that enables the distributed parallel processing. Specifically, the MPA 120 manages the distributed processing resources and the transfers of pluralities of data streams from and to the remote processing nodes 130. The main computing node 110 preferably includes at least one processor (e.g., central processing unit (CPU)) 115 for executing various processing tasks.

Each of remote processing nodes 130 includes a remote script engine 131, a remote data streamer 132 for receiving and transforming data streams, a remote database 133, and a third party interface 134. The third party interface 134 interfaces with at least a third party analysis and/or optimization engine 140. Each engine 140 may be, but is not limited to, a timing analysis engine such as static timing analysis (SAT) or statistical static timing analysis (SSAT), a functional verification engine, such as ATPG, BDD, or an engine capable of performing power analysis. In accordance with an embodiment of the present invention an engine 140 is a timing analysis engine that is fully incremental with on-chip verification and signal integrity capabilities. Each of engine 140 includes at least one processor (not shown) being capable of performing various processing tasks.

A remote processing node 130 preferably includes at least one processor (e.g., a CPU) 135 having its own operating system and being capable of performing various processing tasks. The remote processing nodes 130 are part of a computer farm where workload management for achieving the maximum utilization of computing resources is performed by the MPA 120. The communication between the main computing node 110 and a remote processing node 130 is performed over a network 105. The architecture and the operation of system 100 is described in greater detail in U.S. patent application Ser. No. 11/315,892 entitled “System for Performing Parallel Distributed Processing for Physical Layout Generation” assigned to the common assignee and hereby incorporated by reference for all that it contains.

In accordance with the present invention, the main database 111 includes the entire design in a form of a netlist or a routed layout. The main computing node 110 further holds a list of scenarios to be tested, where each scenario may be described as an independent constraint file. Each scenario is executed on its own remote processing node 130. In other embodiments it is possible to run several scenarios on one of the remote processing nodes 130. The remote databases 133 include the entire design or portions of the design, each of which relates to the scenario executed by the respective remote processing node 130. A scenario run on a remote node 130 is tested using an engine 140. If the engine 140 detects a result that does not meet the constraints, that result is reported to the main computing node 110. Consequently, the main node 110 suggests optimization(s) that are then tested on each scenario running on the remote processing nodes 130. If an optimization in one scenario causes a failure (i.e., a result that does not meet the constraints) in another scenario, that optimization is discarded and a different approach is evaluated. It should be noted that optimizations suggested by the main computing node 110 are propagated to the remote processing node 130 preferably as incremental changes to the database (“transactions”). Similarly, preferably only incremental changes that result from testing the scenarios are returned from the remote processing nodes 130 to the main computing node 110.

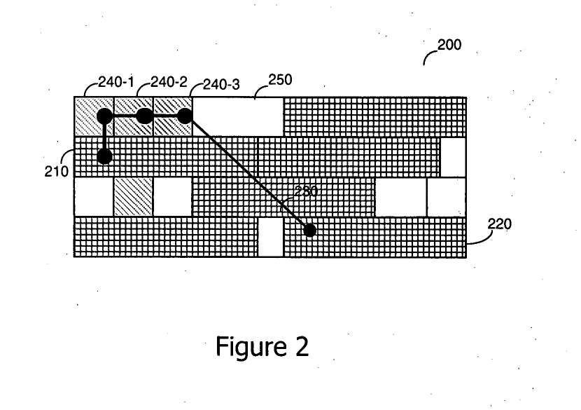

The following is a non-limiting example of the operation of the process for concurrent optimization of multiple scenarios. FIG. 2 shows a layout of an IC design 200 with two clocked cells 210 and 220. A path 230 is established between cells 210 and 220 through three buffers 240-1, 240-2 and 240-3. In a standard IC design cells are latches, logic gates, and so on which are placed in abutting rows. To allow connection between two cells there is some unused space (marked as 250). Buffers are typically placed in the unused space to satisfy the design timing and power constraints. In accordance with this example of the present invention, the design 200 is sent to all remote processing nodes 130 where each node tests a different scenario. In a scenario-A, the path 230 is reported as a critical path, i.e., a path with a negative slack. The timing analysis engine 140 that tests scenario-A reports the slack value (e.g., −0.20 nS) of path 230 to the main computing node 110, which determines how to optimize the path 230. Possible optimization changes for consideration could be: removing a buffer 240, resizing cell 210 or cell 220, using different type of buffers, and so on. If, for example, the selected optimization change is to remove buffer 240-1, then only this change is communicated to all remote nodes 130. Then, each of these nodes tests, in parallel by means of engines 140, the effects of this change. If this change affects the timing of path 230 in other scenario(s), e.g. scenario-B, an incremental timing change is sent from the remote node 130 that runs scenario-B. In response the main processing node 130 may decide either to roll-back (i.e., undo the last optimization change), re-optimize the design 200 by generating a new change, or ignore the timing result reported in the case of scenario-B, if this scenario has more relaxed requirements.

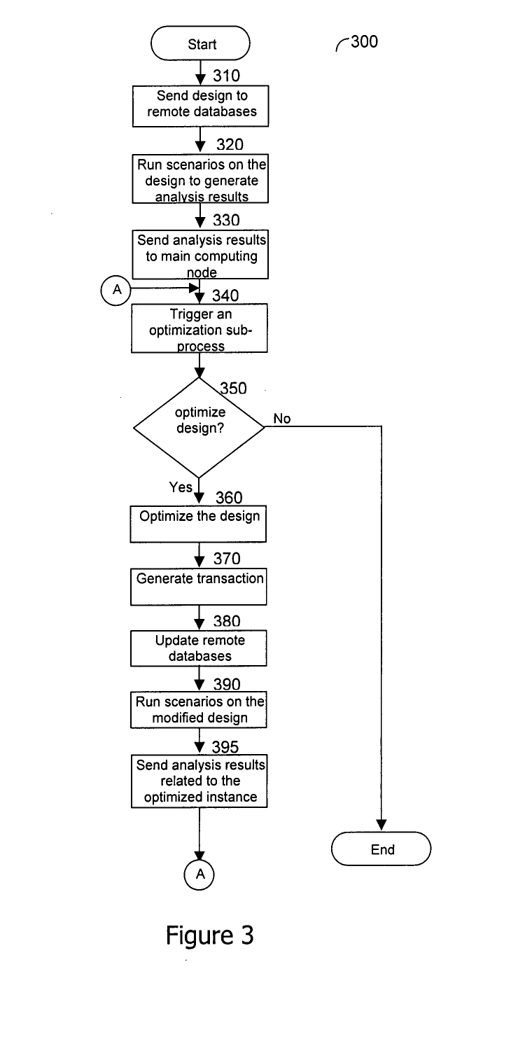

FIG. 3 shows a non-limiting and exemplary flowchart 300 describing the method for simultaneous multi-scenario optimization of IC designs in accordance with an embodiment of the present invention. The method will be described with reference to the distributed multi-processing system shown in FIG. 1. As mentioned above the main computing node 110 maintains the entire design and a list of scenarios to be tested. The scenarios may be prioritized according to their importance. That is, which of the scenarios must be satisfied and which may have more relaxed requirements, in order to ensure the proper operation of the design.

At 310 the IC design that resides in the main database 111 is sent to remote processing nodes 130. The design is sent as a data stream, i.e., the database 111 is not file based, but is designed to stream incremental changes to the data structures as required. In other embodiments different portions of the design may be sent to the remote nodes 130, including but not limited to partitions of designs. In an exemplary embodiment, the design may typically be of a digital IC developed using 90 nanometer technology node and smaller. However the principles disclosed herein may be used for other designs as well. At 320, once the design (or a portion of the design) is saved in a remote database 133, the respective scenario is executed by each respective remote processing node 130 using the analysis/optimization engine 140 coupled to the remote processing node 130. While executing the scenario, each engine 140 may report results with regard to the optimization or analysis being performed. That is, changes may be related to timing, power, or functional verification. For example, if engine 140 performs timing analysis then slack or slew values are generated. At 330 analysis results, generated at 320, are sent to the main computing node 110. At 340, upon receipt of the incremental changes, an optimization sub-process at the main computing node is triggered. Subsequently, at 350 it is determined, by the sub-process optimization, whether the received results indicate the design should be optimized. This can be done, for example, by checking the priority of the scenario that generates the results. If the analysis results do not meet the design requirements, execution continues with 360; otherwise, execution terminates. At 360 the design is optimized to achieve better timing and/or power consumption and in order to resolve the failure as reflected by the incremental changes. As a result of the design optimization, at 370, a transaction is generated and propagated to remote processing nodes 130. A transaction includes one or more of incremental changes to the design's database. For example, a transaction may be in the following format:

<database operation, instance>;

where the database operation may be either insert, remove, swap, or modify, and an instance may be a wire, a cell, a buffer, a net, and the like. At 380, the remote databases 133 are updated based on the received transaction, and thereafter at 390 all engines 140 are triggered to test the scenarios on the modified design in parallel. At 395, each remote node 130 sends analysis results related to the optimized instance to the main node 110. Then execution returns to 340 to check whether the transaction (i.e., suggested optimization) improved or damaged the performance.

The method, main computing node, and remote processing nodes can be implemented in hardware, software, firmware, middleware or a combination thereof, and utilized in systems, subsystems, components, or sub-components thereof. Furthermore, the method, main computing node, and remote processing nodes can be implemented in subsystems, components, or sub-components thereof of a computer aided design (CAD) system.

What is claimed is:

1. A method for concurrently performing optimization of an integrated circuit (IC) design in a plurality of scenarios, the method comprising:
providing a plurality of remote processing nodes with the IC design;
concurrently executing the plurality of scenarios by a plurality of analysis engines coupled to the remote processing nodes;
by each analysis engine, reporting analysis results for each of the scenarios to a main computing node; and,
generating at the main computing node a transaction for at least one proposed incremental change to the IC design.

2. The method of claim 1, further comprising:
propagating the transaction to the plurality of remote processing nodes;
updating a design database in each of the remote processing nodes according to the transaction; and
by all analysis engines, concurrently testing the plurality of scenarios on the proposed optimization.

3. The method of claim 2, wherein a scenario comprises a combination of a functional mode of the IC design and a process corner.

4. The method of claim 3, wherein the process corner comprises any combination of temperature, power and manufacturing process.

5. The method of claim 1, wherein providing the IC design further comprises:
sending the IC design from the main computing node to the processing nodes as data streams.

6. The method of claim 5, wherein the IC design is in a form of a netlist or a routed layout.

7. The method of claim 5, wherein the IC design comprises at least one portion of a larger IC design.

8. The method of claim 1, wherein each analysis engine is coupled to a respective remote processing node.

9. The method of claim 8, wherein the analysis engines comprise a timing verification engine, a functional verification engine, and a power verification engine.

10. The method of claim 1, wherein the analysis results are for a single design instance.

11. The method of claim 10, wherein the design instance comprises at least one of: a wire, a cell, a buffer, a net.

12. The method of claim 1, wherein optimizing the IC design further comprises:
checking the priority of the scenario that generates the analysis results; and
determining whether the analysis results indicate that the design should be optimized.

13. The method of claim 1, wherein the transaction comprises at least one incremental change to the IC design database.

14. The method of claim 13, wherein the transaction includes a database operation and a design instance.

15. The method of claim 14, wherein the database operation includes at least one of: insert, remove, swap, modify.

16. The method of claim 2, wherein the method is repeated until the entire design is optimized.

17. A machine-readable medium that provides instructions to implement a method for concurrently performing optimization of an integrated circuit (IC) design in a plurality of scenarios, which instructions, when executed by a first set of processors, a second set of processors and one or more third processors, cause to perform operations comprising:
providing a plurality of remote processing nodes with the IC design, wherein the remote processing nodes include the first set of processors;
concurrently executing the plurality of scenarios by analysis engines coupled to the remote processing nodes, wherein the analysis engines include the second set of processors;
by each analysis engine, reporting analysis results to a main computing node, wherein the main computing node includes the third processors; and
generating, based on the analysis results, a transaction for at least one proposed incremental change to the IC design.

18. The machine-readable medium of claim 17, further comprising:
propagating the transaction to the plurality of remote processing nodes;
updating a design database in each of the remote processing nodes according to the transaction; and
by all analysis engines, concurrently testing the plurality of scenarios on the proposed optimization.

19. The machine-readable medium of claim 18, wherein a scenario comprises a combination of an operation mode of the IC design and a process corner.

20. The machine-readable medium of claim 19, wherein the process corner comprises any combination of temperature, power supply and manufacturing process.

21. The machine-readable medium of claim 18, wherein providing the IC design further comprising:
sending the IC design from the main computing node to the processing nodes as data streams.

22. The machine-readable medium of claim 21, wherein the IC design is in a form of a netlist or a routed layout.

23. The machine-readable medium of claim 21, the IC design comprises at least one portion of the IC design.

24. The machine-readable medium of claim 18, wherein each analysis engine is coupled to a remote processing node.

25. The machine-readable medium of claim 24, wherein the analysis engine comprises at least one of: a timing analysis engine, a formal verification engine, a power optimization engine.

26. The machine-readable medium of claim 18, wherein the analysis results refer to a single design instance.

27. The machine-readable medium of claim 26, wherein the design instance comprises at least one of: a wire, a cell, a buffer, a net.

28. The machine-readable medium of claim 18, wherein optimizing the IC design further comprising:
checking the priority of the scenario that generates the analysis results; and
determining whether the analysis results indicate that the design should be optimized.

29. The machine-readable medium of claim 17, wherein the transaction comprises at least one incremental change to the IC design database.

30. The machine-readable medium of claim 29, wherein the transaction includes a database operation and a design instance.

31. The machine-readable medium of claim 30, wherein the database operation includes at least one of: insert, remove, swap, modify.

32. The machine-readable medium of claim 18, wherein the method is repeated until the entire IC design is optimized.

33. A distributed computing system for concurrently performing optimization of an integrated circuit (IC) design in a plurality of scenarios, the system comprising:
a main computing node having at least a multi-processing agent for generating transactions for proposed optimizations, wherein the main computing node includes a database for maintaining the IC design;
a plurality of remote processing nodes, each of the plurality of remote processing nodes including a database for maintaining the IC design;
a plurality of analysis engines coupled to the remote processing nodes and programmed for concurrently executing one or more of the plurality of scenarios, wherein each or the plurality of analysis engines is further capable of reporting analysis results to the respective remote processing node; and
a communication network for communication between the main computing node and the plurality of remote processing nodes.

34. The system of claim 33, wherein a scenario comprises a combination of an functional mode of the IC design and a process corner.

35. The system of claim 34, wherein the process corner comprises any combination of temperature, power and manufacturing process.

36. The system of claim 33, wherein the main computing node is further configured to send the IC design to the remote processing nodes through the communication network as data streams.

37. The system of claim 36, wherein the IC design is in a form of a netlist or a routed layout.

38. The system of claim 37, wherein the IC design comprises at least one portion of a larger IC design.

39. The system of claim 36, wherein the transactions are generated based on the analysis results.

40. The system of claim 39, wherein generating the transactions comprise:
checking the priority of the scenario that generates the respective analysis results; and
determining whether the respective analysis results indicate that the design should be optimized.

41. The system of claim 40, wherein a transaction includes a database operation and a design instance.

42. The system of claim 41, wherein the database operation includes at least one of: insert, remove, swap, modify.

43. The system of claim 40, wherein the transactions are propagated to the remote processing nodes through the communication network.

44. The system of claim 43, wherein each remote processing node updates its database according to the transactions.

45. The system of claim 44, wherein the analysis engines are further configured for concurrently testing the plurality of scenarios on the proposed optimization.

46. The system of claim 33, wherein an analysis engine comprises at least one of: a timing verification engine, a functional verification engine, and a power verification engine.

47. The system of claim 46, wherein the analysis results relate to a single design instance.

48. The system of claim 47, wherein the design instance comprises at least one of: a wire, a cell, a buffer, a net.

49. The system of claim 33, wherein the IC design is a digital IC developed using a 90 nanometer technology node.

50. The system of claim 33, wherein the IC design is a digital IC developed using a technology node smaller than 90 nanometer.
